(19) United States
(12) Patent Application Publication
(10) Pub. No.: US 2022/0146804 A1
(43) Pub. Date: May 12, 2022

(54) LASER SCANNING MICROSCOPE AND METHOD FOR ADJUSTING A LASER SCANNING MICROSCOPE

(71) Applicant: Carl Zeiss Microscopy GmbH, Jena (DE)

(72) Inventor: Nikolaj SCHRÖDER, Jena (DE)

(73) Assignee: Carl Zeiss Microscopy GmbH, Jena (DE)

(21) Appl. No.: 17/523,214

(22) Filed: Nov. 10, 2021

(30) Foreign Application Priority Data
Nov. 11, 2020 (DE) 10 2020 006 975.4

(51) Int. Cl. G02B 21/00; G02B 21/06

(52) U.S. Cl. CPC G02B 21/0044; G02B 21/006; G02B 21/0076; G02B 21/06

(57) ABSTRACT

A laser scanning microscope and method for adjusting a laser scanning microscope. The microscope has an optical system which has a light guiding fiber between the first light source and the third beam deflection unit and has no light guiding fibers between the second light source and the third beam deflection unit. In this way, the second light source can be used as an adjustment reference for the first and second beam deflection units. The adjustment can be implemented using test images recorded by means of the third and fourth beam deflection units; additional sensors or internal calibration samples are not required.

### RELATED APPLICATIONS

The present application claims priority benefit of German Application No. DE 10 2020 006 975.4 filed on Nov. 11, 2020, the contents of which are incorporated by reference in their entirety.

### FIELD OF THE INVENTION

The invention relates to a laser scanning microscope (“LSM”) with an optical system which includes two light sources, an optoelectronic detector, four movable beam deflection units and a microscope objective with a pupil plane and a focal plane. The third and the fourth of the beam deflection units are arranged in, or in the vicinity of, a plane that is conjugate to the pupil plane, while the first and the second of the beam deflection units are arranged upstream of the third and upstream of the fourth beam deflection unit in the illumination direction. The optical system guides light from the first light source through the objective into the focal plane via the four beam deflection units, guides light from the second light source through the objective into the focal plane via the third and the fourth of the beam deflection units but not via the first and the second beam deflection unit, and images a point of the focal plane through the objective onto the detector. The invention further relates to a method for adjusting a laser scanning microscope. The illumination direction extends from the relevant light source to the focal plane.

### BACKGROUND OF THE INVENTION

If multiphoton fluorescence excitation should be implemented in an LSM, a correspondingly long wavelength, high intensity (N)IR pulse laser is required. If such lasers are fed into a microscope via light guiding fibers, there is unwanted spectral and temporal broadening of the light pulses. Therefore, they are usually input coupled as a free beam without fibers. However, this is accompanied by an increased need for adjustment since the free beam introduces four additional degrees of freedom into the system. Should the system comprise further lasers, be these lasers in the visible range (VIS) or further (N)IR lasers, an alignment of the lasers to one another is imperative in order to be able to record corresponding images over the entire spectrum.

The prior art has disclosed a generic microscope and a generic method in DE 10 2007 011 305 A1. A disadvantage thereof is that commercially available microscopes must be equipped with an internal pivoting apparatus for a calibration sample, requiring great outlay.

Other solutions, such as known from DE 101 11 824 A1 for example, do not require an internal calibration sample but instead require two internal position-sensitive sensors for ascertaining the relative beam position. This is also a complicated modification of the device.

Stabilizing a free beam outside of the microscope is also known, for example from EP 1959291 A2. In turn, this requires additional position-sensitive sensors for ascertaining the relative beam position, albeit outside of the actual microscope. However, a constant relative beam position upstream of the microscope does not yet ensure correct input coupling of the free beam up to the objective.

### SUMMARY OF THE INVENTION

The invention is based on the object of improving a microscope of the type set forth at the outset so that a fiber-coupled laser and a fiber-free coupled laser can be aligned to one another within a microscope with less outlay than previously in order to facilitate correct input coupling up to the objective.

The object is achieved by a microscope having the features specified in the independent apparatus claim and by a method having the features specified in the independent method claim.

Insofar as components are referred to as “first”, “second”, “third” or “fourth” of a particular type in the claims, this label does not specify any sequence of the arrangement in the optical system but only serves for terminological distinction.

Advantageous refinements of the invention are specified in the dependent claims.

According to the invention, provision is made for the optical system to have a light guiding fiber between the first light source and the third beam deflection unit and to have no light guiding fibers between the second light source and the third beam deflection unit.

The invention is based on the discovery that a laser that has been input coupled by way of a light guiding fiber (“second light source”) can be used as an adjustment reference since the optical system is usually already aligned, and also remains aligned, on the basis of its beam, wherein a sample conventionally arranged in front of the objective can be used to adjust a free beam laser (“first light source”).

In this way, the adjustment is successful with little outlay since there is no need for additional internal sensors and also no need for an internal calibration sample. Preferably, the first light source is an ultrashort pulse laser which emits in the (N)IR range.

An automatic adjustment of the free beam laser is possible if the microscope comprises a control unit which records a test image through the objective by means of the detector under illumination by the first light source for the purposes of adjusting the optical system, wherein it scans the focal plane by means of the third and fourth beam deflection unit, and sets the first and/or the second beam deflection unit using the test image, in particular in a plurality of iterations of test image recording and setting of the relevant beam deflection unit. Scanning the focal plane means that an illumination spot is successively moved to different positions within the focal plane so that a sample situated in the focal plane, in particular a calibration sample as well, is excited to fluoresce.

An LSM in which the control unit ascertains a characteristic for an illumination of the test image and sets the first beam deflection unit, which is arranged upstream or downstream of the second beam deflection unit in the illumination direction, on the basis of the ascertained characteristic is advantageous. This facilitates adjustment of two of the four degrees of freedom of the free beam with little outlay. Advantageously, a homogeneity of the illumination of the test image and/or an intensity of the illumination of the test image can be ascertained as the characteristic the control unit uses to set the first beam deflection unit. This facilitates a high accuracy during the adjustment. By way of example, the intensity can be ascertained by virtue of integrating the intensities of all pixels of the test image. The intensity can be the more sensitive characteristic, especially in the case of large magnifications or a high zoom factor.

Moreover, an advantageous LSM has a control unit which records a test image through the objective by means of the detector under illumination by the first light source for the purposes of adjusting the optical system, wherein it scans the focal plane by means of the third and fourth beam deflection unit, records a reference image from the focal plane therebefore or thereafter under illumination by the second light source, wherein it scans the focal plane by means of the third and fourth beam deflection unit, and ascertains a geometric offset between the test image and the reference image and sets the second beam deflection unit, which is arranged upstream or downstream of the first beam deflection unit in the illumination direction, on the basis of the ascertained offset. This facilitates adjustment of the two other degrees of freedom of the free beam with little outlay. In this case, the reference image can be recorded at any time before or after the test image has been recorded.

Embodiments in which the control unit initially iteratively sets the first beam deflection unit on the basis of a characteristic using test images (“inner iteration”) and subsequently, for example after a given threshold for the characteristic has been reached (undershot or overshot) so that the control unit terminates the inner iteration, sets the second beam deflection unit on the basis of the offset using a test image and a reference image are particularly preferred. Preferably, the control unit thereupon carries out a further (“outer”) iteration, which starts with an iterative setting of the first beam deflection unit using at least one further test image. Thereupon, an offset between test image and reference image is ascertained again and the second beam deflection unit is set on the basis of the offset. The iterations are terminated if, for example, the offset reaches (undershoots) a further specified threshold. Advantageously, the control unit can ascertain the offset using the test image respectively recorded last during the iterative setting of the first beam deflection unit. In this way there is no need to record an image again, accelerating the adjustment.

In the case of such configurations in which the control unit initially sets the first beam deflection unit on the basis of the characteristic for the illumination and only subsequently sets the second beam deflection unit on the basis of the offset, the control unit preferably keeps the setting of the first beam deflection unit constant while the second beam deflection unit is set. This allows an adjustment of all four degrees of freedom to be attained in the shortest possible amount of time.

A control unit is provided in an alternative embodiment, which records a first test image through the objective by means of the detector for the purposes of adjusting the optical system, wherein it scans the focal plane by means of the third and fourth beam deflection unit, then displaces the focal plane by means of an adjustable focusing unit and records a second test image from the displaced focal plane through the objective by means of the detector, wherein it scans the displaced focal plane by means of the third and fourth beam deflection unit, and ascertains a geometric offset between the first test image and the second test image and sets the second beam deflection unit, which is arranged upstream or downstream of the first beam deflection unit in the illumination direction, on the basis of the ascertained offset, wherein the first test image is recorded under illumination by a different one of the light sources than the second test image or wherein both test images are recorded under illumination by the first light source. The offset between images from different focal planes allows the ascertainment of an angle deviation of the beam in the pupil plane, through which the usually telecentric objective focuses on an offset point.

In special configurations in which only test images under illumination by the first light source are recorded, it is possible to dispense with the second, fiber-coupled light source.

In this embodiment, too, the control unit can, as described above, initially set the first beam deflection unit on the basis of the illumination in “inner” iterations and subsequently record a first and a second test image and set the second beam deflection unit using the offset. These steps can be repeated in an “outer” iteration such that the iterative setting of the first beam deflection unit is initially repeated and terminated, for example when the given threshold is reached, and the second beam deflection unit is subsequently set. This allows an adjustment of all four degrees of freedom to be attained in the shortest possible amount of time.

Expediently, a calibration sample with a symmetrical arrangement of the fluorescence emitters in the z-direction is arranged in the region of the focal plane for this embodiment. The offset can then advantageously be ascertained using test images recorded by the control unit in focal planes in which the fluorescence emitters are distributed in congruent fashion. As a result, the offset can be ascertained with a greater accuracy.

Setting different focal planes is accomplished using means already available in conventional laser scanning microscopes, by virtue of the adjustable focusing unit comprising the objective or by virtue of the focusing unit comprising a collimation optical unit which is optically arranged between the second and third beam deflection unit (in particular also optically between the first and third beam deflection unit), in particular with displaceability of the collimation optical unit along an optical axis of the illumination for the purposes of setting different focal planes. In this way, no modifications of available LSMs are required.

Preferably, the first and the second beam deflection unit are each formed as a mirror which is rotatable about two different spatial axes. As a result, adjusting the four degrees of freedom of the free beam requires a minimal amount of space. As an alternative or in addition thereto, the first and/or the second beam deflection unit can be displaceable, in particular linearly displaceable. All beam deflection units comprise a motor drive, which is electrically or electronically connected to the control unit. A rotatable plane plate, in particular with plane-parallel surfaces, can also be used in place of a rotatable or displaceable mirror. It can produce an adjustable beam offset.

Preferably, the third and the fourth beam deflection unit are each formed as a mirror which is rotatable about exactly one spatial axis, in particular each formed as a galvanometer mirror, wherein the spatial axis differs between the two beam deflection units, or wherein the third and the fourth beam deflection unit are formed together by one mirror which is rotatable about two different spatial axes. In this way, high quality and high speed image recording is possible in accordance with the known laser scanning principle.

Advantageously, no calibration sample is optically placeable between the light sources and the objective. Advantageously, the optical system between the first beam deflection unit and the objective and between the second beam deflection unit and the objective is without branchings to sensors for ascertaining a beam position and/or a beam direction. Advantageously, the first and second beam deflection unit have a constant setting for the duration of each image recording (scanning the focal plane using the third and the fourth beam deflection unit).

The invention is also directed to a method for adjusting a laser scanning microscope with an optical system which has two light sources, an optoelectronic detector, four movable beam deflection units and a microscope objective with a pupil plane and a focal plane. The third and the fourth of the beam deflection units are arranged in, or in the vicinity of, a plane that is conjugate to the pupil plane, while the first and the second of the beam deflection units are arranged upstream of the third and the fourth beam deflection unit in the illumination direction. The optical system guides light from the first light source through the objective into the focal plane via the four beam deflection units and the beam splitters, guides light from the second light source through the objective into the focal plane but not via the first and the second beam deflection units and images a point of the focal plane through the objective onto the detector. The optical system has a light guiding fiber between the first light source and the third beam deflection unit and has no light guiding fibers between the second light source and the third beam deflection unit, wherein a test image is recorded through the objective by means of the detector under illumination by the first light source by virtue of the focal plane being scanned by means of the third and fourth beam deflection unit. The first and/or the second beam deflection unit is set using the recorded test image, in particular in a plurality of iterations of recording a test image and setting the relevant beam deflection unit. The above-described advantages are achieved in this way. In general, each step carried out by the control unit above can be a general step of the method according to the invention without having to be carried out by a control unit.

Preferably, the first beam deflection unit, which is arranged optically upstream or downstream of the second beam deflection unit, is set in this case on the basis of a characteristic for illuminating the test image, in particular a homogeneity and/or intensity of the illumination of the test image as the characteristic.

Preferably, the second beam deflection unit is set on the basis of an offset between a reference image recorded under illumination by the second light source and a test image recorded under illumination by the first light source or on the basis of an offset between a first test image recorded under illumination by the first light source and a second test image recorded under illumination by the first light source or by the second light source, wherein the focal plane is displaced by means of an adjustable focusing unit, in particular the objective and/or a collimation optical unit, between the recording of the first and the second test image.

In all the embodiments described, configurations in which the first beam deflection unit (which is primarily adjusted on the basis of the illumination) is arranged upstream of the second beam deflection unit (which is primarily adjusted on the basis of the image offset) in the illumination direction are preferred since the free beam is adjustable over a maximal spatial and angular range in this configuration.

### BRIEF DESCRIPTION OF THE DRAWINGS

The invention is explained in more detail below on the basis of exemplary embodiments.

In the drawings:

FIG. 1 illustrates a laser scanning microscope with an improved beam adjustment option,

FIG. 2A illustrates a beam path which is out of adjustment relative to the angle in the pupil plane,

FIG. 2B illustrates the beam path post adjustment,

FIG. 3A also illustrates a beam path that is out of adjustment relative to the angle in a focal plane,

FIG. 3B illustrates both beams post adjustment,

FIG. 4 is a flow chart illustrating a possible procedure for adjusting all the degrees of freedom using a reference beam,

FIG. 5 is a flow chart illustrating a possible procedure for adjusting all the degrees of freedom using test images from different focal planes by means of an objective adjustment, and

FIG. 6 is a flow chart illustrating a possible procedure for adjusting all the degrees of freedom using test images from different focal planes by means of a collimator adjustment.

### DETAILED DESCRIPTION OF THE DRAWINGS

In all of the drawings, corresponding parts bear the same reference signs.

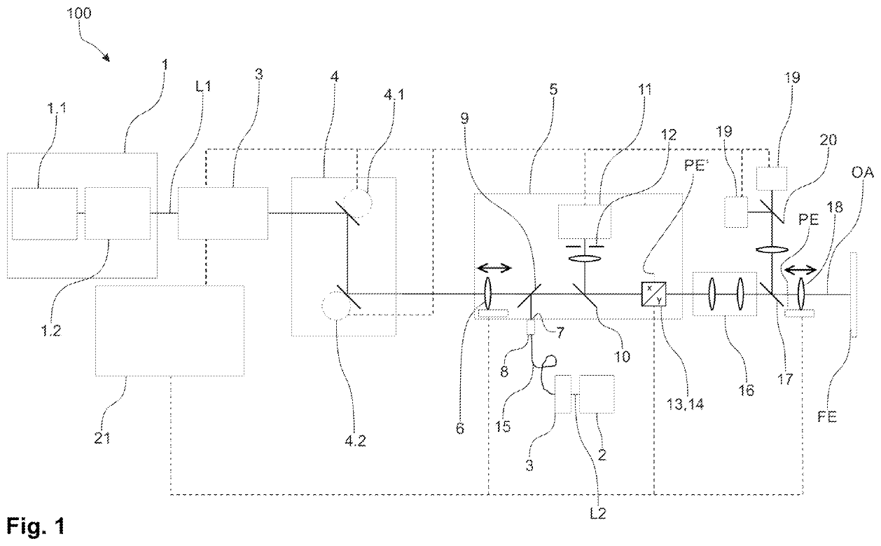

FIG. 1 shows a laser scanning microscope 100 having a first light source 1, which contains for example a Ti:sapphire ultrashort pulse laser 1.1 which emits in the NIR range and a prechirp unit 1.2 for compensating the group velocity dispersion, and a second light source 2, for example a laser diode, which emits in the VIS range. By way of an adjustable attenuator 3, for example an AOM, light from the first light source 1 reaches a periscope 4. The periscope 4 contains a first beam deflection unit 4.1 and a second beam deflection unit 4.2, each of which comprise a mirror which is rotatable about two axes and which has a motor drive. Subsequently, the light from the first light source 1 reaches the scanning module 5 which contains a movable collimation optical unit 6, a connector 7 for a fiber plug 8, a dichroic beam splitter 9, a principal color splitter 10 and a detector 11 with a confocal stop 12, and also contains a third beam deflection unit 13 and a fourth beam deflection unit 14, each in the form of a galvanometer scanner, for example. The fiber plug 8 is part of a light guiding fiber 15 which connects the second light source 2 to the scanning module 5 via a further adjustable attenuator 3. Light from the two light sources 1 and 2 is merged by way of a dichroic beam splitter 3 before it passes the principal color splitter 10 such that both beams are influenced together by the third and fourth beam deflection unit 13, 14 before said beams emerge from the scanning module 5 and reach the objective 18 through the microscope stand 16 and a further dichroic beam splitter 17, which for example is able to be swiveled away, and are focused into the focal plane FE at said objective.

By way of example, the objective 18 overall, or only an internal lens group, is movable in motor-driven fashion along its optical axis in order to displace the focal plane. As an alternative or in addition thereto, the collimation optical unit 6 can be movable along the optical axis in motor-driven fashion in order to compensate longitudinal chromatic aberrations on a wavelength-individual basis and thereby effectively likewise displace the focal plane.

In addition to the confocal detector 11 which facilitates a descanned detection, the microscope 100 also comprises two NDD detectors 19 (without confocal stops) which are linked to the optical system by means of the beam splitter 17 and by means of a further dichroic beam splitter 20. These facilitate a non-descanned detection. By way of an appropriate choice of the dichroic beam splitter 20 the two NDD detectors 19 are able to simultaneously detect different wavelength ranges. In the imaged configuration, the confocal detector 11 can only detect one wavelength range at any one time. In order to be able to change the latter sequentially, the principal color splitter 10 can be arranged in interchangeable fashion on a filter wheel (not imaged) that is movable in motor-driven fashion or an appropriate filter can be arranged in interchangeable fashion upstream of the detector 11 on a filter wheel (not imaged) that is movable in motor-driven fashion. As an alternative or in addition thereto, one or more further detectors can be arranged for confocal, descanned, simultaneous detection of a plurality of wavelength ranges by way of one or more additional dichroic beam splitters. No confocal stops 12 are required if only fluorescence from multi-photon excitation is measured, particularly in optional embodiments without the second light source 2.

The movable components of the microscope 100 are controlled by a control unit 21 which, to this end, is electrically connected to the components and also to the detectors (and possibly present filter wheels).

The periscope 4 allows setting of the four degrees of freedom of the light L1 from the first light source 1 that has been input coupled into the scanning module 5 as a free beam.

The control unit 21 can have a user interface by means of which the first (4.1) and the second (4.2) beam deflection unit is adjustable by a user, for example in increments of different sizes. To this end, the user interface can indicate a respective pointer for each axis of rotation, which informs the user about the sum of the steps in each direction. As a result, an earlier state can be reestablished with little outlay.

Preferably, the control unit is configured electronically or in terms of programming to automatically undertake the adjustment.

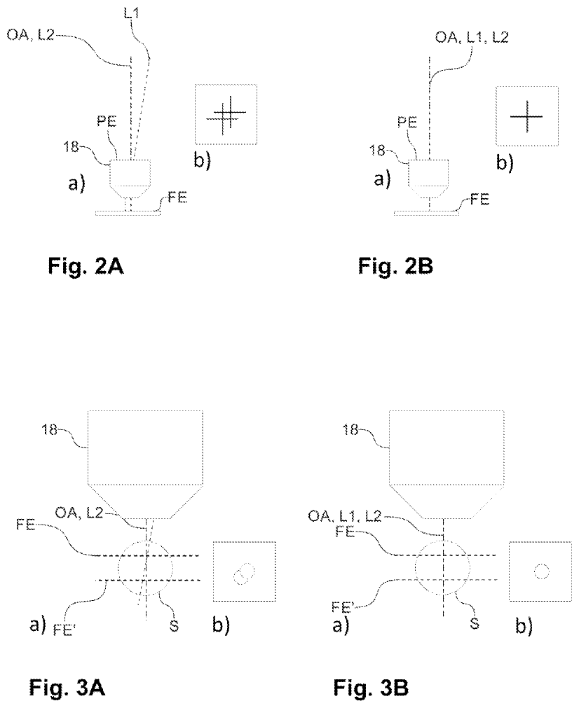

In FIG. 2A, part a) illustrates a beam path of the NIR light L1 (chief axis of the beam) which is out of adjustment in relation to the angle in the pupil plane PE. The VIS light L2 from the second light source (chief axis of the beam) extends along the optical axis OA of the objective 18 since the scanning module 5 has already been adjusted using this beam. If an image is recorded using VIS illumination L2 and an image is recorded using NIR illumination L1 and if these images are superimposed, they do not correspond, as illustrated in part b), but have an offset instead. Following the adjustment, both beams are located on the optical axis as illustrated in FIG. 2B, part a). If, as previously, two images are recorded with different illuminations, they now correspond as illustrated in part b).

In FIG. 3A, part a) also illustrates a beam path of the NIR light L1 (chief axis of the beam) which is out of adjustment in relation to the angle in the focal plane FE. A calibration sample with fluorescence emitters arranged with a spherical symmetry or a cylindrical symmetry, for example in the form of one or more latex beads, is arranged in the focal plane FE. The VIS light L2 from the second light source (chief axis of the beam) extends along the optical axis OA of the objective 18 since the scanning module 5 has already been adjusted using this beam. If an image is recorded using NIR illumination L1 in the focal plane FE and an image is recorded using NIR illumination L1 in the displaced focal plane FE′ and if these images are superimposed, they do not correspond, as illustrated in part b), but have an offset instead. Following the adjustment, both beams are located on the optical axis as illustrated in FIG. 3B, part a). If, as previously, two images are recorded in different focal planes FE, FE′, they now correspond as illustrated in part b).

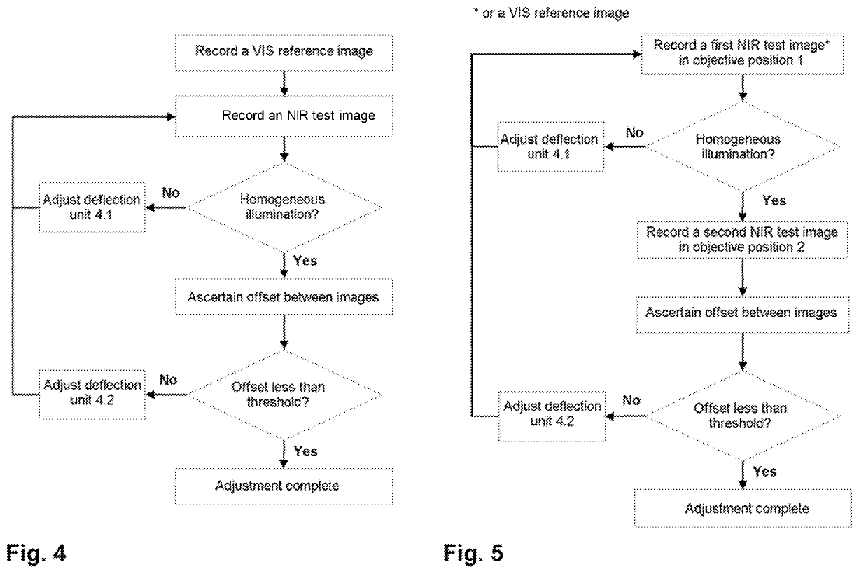

By way of example, the adjustment can proceed according to the scheme illustrated in FIG. 4. To this end, use is preferably made of a thin sample which contains a structure that is able to be imaged by the light sources and which is located within a plane extending at an angle to the optical axis. The sample can be fluorescing or reflecting. By way of example, this can relate to a chromium grating in front of a homogeneous fluorescence material. The sample is preferably recorded in image-filling fashion when the test and/or reference images are recorded. The reliability of the image evaluation can be improved by measures such as averaging if the adjustment must be implemented on a dark sample or using little excitation light, for example in the case of a real biological sample.

Initially, a reference image is recorded and stored using the second light source 2. Then, a test image is recorded iteratively under illumination by the first light source 1 and the illumination thereof is assessed on the basis of a specified criterion, for example whether a specified threshold for the homogeneity has been reached or exceeded. By way of example, the control unit 12 can ascertain a ratio of grayscale values at the image edges to grayscale values in the center of the relevant image as a quantitative characteristic for the illumination, which can be compared to a threshold. Alternatively, profile lines can be placed through objects and a ratio of peak grayscale values arising as a result can be ascertained as the characteristic. Alternatively, a linear function from curve fitting can be fitted to the peaks, the gradient thereof as characteristic of the illumination being compared to a threshold. Should the illumination not be sufficiently homogeneous, independently of the type of characteristic and the manner of its ascertainment, the first deflection unit 4.1 is adjusted and a test image is recorded and assessed again. If the illumination is sufficiently homogeneous according to the specified criterion, the first (“inner”) iteration is terminated. Subsequently, an offset between the reference image and the test image is ascertained and there is an assessment using a further specified criterion, for example whether a specified threshold for the offset has been maximally reached or even undershot. Should the criterion not be satisfied, the second beam deflection unit 4.2 is adjusted and the iterative setting of the first beam deflection unit 4.1 is repeated. This represents an “outer” iteration. If the offset is sufficiently small according to the specified criterion, the second (“outer”) iteration is terminated and hence the adjustment has been completed.

The VIS reference image need not be recorded at the start but can also be recorded at a later time, for example after the first termination of the inner iteration for setting the first beam deflection unit 4.1. In the case where the adjustment is carried out automatically by the control unit 21, the offset can be ascertained by a two-dimensional cross correlation between the relevant images, for example. Setting the first beam deflection unit 4.1 in the “inner” iteration can be carried out using any known optimization method. In addition or as an alternative to the homogeneity, the intensity of the illumination, that is to say the sum of the intensity values of all pixels, can be used as a simple characteristic for the illumination. Then, the specified criterion for the illumination that is checked in the inner iteration is whether a maximum of the integrated intensities is present.

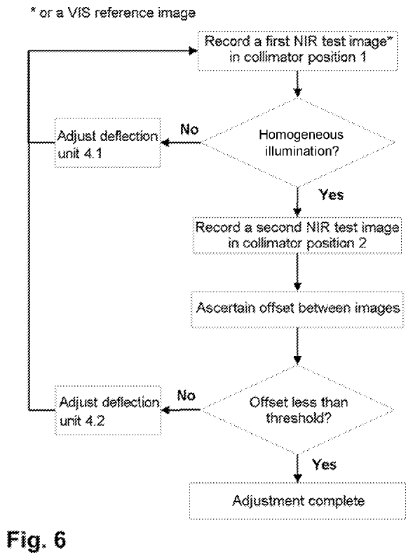

As an alternative to the procedure shown in FIG. 4, the adjustment can proceed according to any one of the schemes illustrated in FIG. 5 or FIG. 6, for example. In FIG. 5 and FIG. 6, the offset between a first test image recorded in the focal plane FE under illumination by the first light source 1 and a second test image likewise recorded under illumination by the first light source 1 but in a different focal plane FE′ is used to set the second beam deflection unit 4.2 instead of an offset between a reference image under illumination by the second light source 2. To this end, the second light source 2 is not required. However, a reference image can be recorded under illumination by the second light source 2 as a replacement for the first test image or as a replacement for the second test image. What is decisive is that the images are recorded in different focal planes FE, FE′. The different focal planes FE, FE′ can be obtained by adjusting a focusing unit, for example by adjusting the objective 18 (like in FIG. 5) or the collimation optical unit 6 (like in FIG. 6).

It is possible to input couple more than one light source per free beam into the microscope 100. For this purpose, a respective first and second beam deflection unit is required for each of these light sources, that is to say an independent periscope 4 for each light source to be input coupled per free beam in the example according to FIG. 1. Each pair of first and second beam deflection unit should then be adjusted separately, either in relation to the second light source 2 (for example like in FIG. 4) or in relation to a light source that has been input coupled per free beam, the first and second beam deflection units of which have already been adjusted (for example once again like in FIG. 4), or by means of an image offset between recordings from different focal planes FE, FE′ (for example once again like in FIG. 5 or FIG. 6).

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### LIST OF REFERENCE SIGNS

1 First light source
   1.1 Ti:sapphire ultrashort pulse laser
   1.2 Prechirp unit
2 Second light source
3 Attenuator
4 Periscope
   4.1 First beam deflection unit
   4.2 Second beam deflection unit
5 Scanning module
6 Collimation optical unit
7 Connector
8 Fiber plug
9 Dichroic beam splitter
10 Principal color splitter
11 Detector
12 Confocal stop
13 Third beam deflection unit
14 Fourth beam deflection unit
15 Light guiding fiber
16 Microscope stand
17 Dichroic beam splitter
18 Objective
19 NDD detector
20 Dichroic beam splitter
21 Control unit
100 Laser scanning microscope
FE(′) Focal plane
PE Pupil plane
L1 Light from the first light source
L2 Light from the second light source
OA Optical axis
S Calibration sample

1. A laser scanning microscope with an optical system which comprises two light sources, an optoelectronic detector, four movable beam deflection units and a microscope objective with a pupil plane and a focal plane, wherein the third and the fourth of the beam deflection units are arranged in or in the vicinity of a plane that is conjugate to the pupil plane and the first and the second of the beam deflection units are arranged upstream of the third and upstream of the fourth beam deflection unit in the illumination direction and the optical system guides light from the first light source through the objective into the focal plane via the four beam deflection units, guides light from the second light source through the objective into the focal plane via the third and the fourth of the beam deflection units but not via the first and the second beam deflection unit, and images a point of the focal plane through the objective onto the detector, wherein the optical system has a light guiding fiber between the first light source and the third beam deflection unit and has no light guiding fibers between the second light source and the third beam deflection unit.

2. The microscope as claimed in claim 1, wherein a control unit which records a test image through the objective by means of the detector under illumination by the first light source for the purposes of adjusting the optical system, wherein said control unit scans the focal plane by means of the third and fourth beam deflection unit, and sets the first and/or the second beam deflection unit using the test image, in particular in a plurality of iterations of test image recording and setting of the relevant beam deflection unit.

3. The microscope as claimed in claim 2, wherein the control unit ascertains a characteristic for an illumination of the test image and sets the first beam deflection unit, which is arranged upstream or downstream of the second beam deflection unit in the illumination direction, on the basis of the ascertained characteristic, in particular with a homogeneity and/or intensity of the illumination of the test image as the characteristic the control unit uses to set the first beam deflection unit.

4. The microscope as claimed in claim 1, wherein a control unit which records a test image through the objective by means of the detector under illumination by the first light source for the purposes of adjusting the optical system, wherein it scans the focal plane by means of the third and fourth beam deflection unit, records a reference image from the focal plane therebefore or thereafter under illumination by the second light source, wherein said control unit scans the focal plane by means of the third and fourth beam deflection unit, and ascertains a geometric offset between the test image and the reference image and sets the second beam deflection unit, which is arranged upstream or downstream of the first beam deflection unit in the illumination direction, on the basis of the ascertained offset, in particular in a plurality of iterations of iteratively setting the first beam deflection unit, subsequently recording the test image and setting the second beam deflection unit.

5. The microscope as claimed in claim 4, wherein the control unit initially sets the first beam deflection unit on the basis of the characteristic for the illumination and only then sets the second beam deflection unit on the basis of the offset, wherein, in particular, the setting of the first beam deflection unit remains constant.

6. The microscope as claimed in claim 1, wherein a control unit which records a first test image through the objective by means of the detector for the purposes of adjusting the optical system, wherein said control unit scans the focal plane by means of the third and fourth beam deflection unit, then displaces the focal plane by means of an adjustable focusing unit and records a second test image from the displaced focal plane through the objective by means of the detector, wherein it said control unit scans the displaced focal plane by means of the third and fourth beam deflection unit, and ascertains a geometric offset between the first test image and the second test image and sets the second beam deflection unit, which is arranged upstream or downstream of the first beam deflection unit in the illumination direction, on the basis of the ascertained offset, wherein the first test image is recorded under illumination by a different one of the light sources than the second test image or wherein both test images are recorded under illumination by the first light source, in each case in particular in a plurality of iterations of iteratively setting the first beam deflection unit, subsequently recording the first and second test images and setting the second beam deflection unit.

7. The microscope as claimed in claim 6, wherein the adjustable focusing unit comprises the objective or wherein the focusing unit comprises a collimation optical unit which is optically arranged between the second and the third beam deflection unit, in particular with displaceability of the collimation optical unit along an optical axis of the illumination for the purposes of setting different focal planes.

8. The microscope as claimed in claim 1, wherein the first and the second beam deflection unit are each formed as a mirror which is rotatable about two different spatial axes.

9. The microscope as claimed in claim 1, wherein the third and the fourth beam deflection unit are each formed as a mirror which is rotatable about exactly one spatial axis, in particular each formed as a galvanometer mirror, wherein the spatial axis differs between the two beam deflection units, or wherein the third and the fourth beam deflection unit are formed together by one mirror which is rotatable about two different spatial axes.

10. A microscope, wherein no calibration sample is optically placeable between the light sources and the objective and/or wherein the optical system between the first beam deflection unit and the objective and between the second beam deflection unit and the objective is without branchings to sensors for ascertaining a beam position and/or a beam direction, and/or wherein the first and second beam deflection unit have a constant setting for the duration of each image recording.

11. A method for adjusting a laser scanning microscope with an optical system which comprises two light sources, an optoelectronic detector, four movable beam deflection units and a microscope objective with a pupil plane and a focal plane, comprising
arranging the third and the fourth of the beam deflection units in or in the vicinity of a plane that is conjugate to the pupil plane,
arranging the first and the second of the beam deflection units upstream of the third and the fourth beam deflection unit in the illumination direction and the optical system guides light from the first light source through the objective into the focal plane via the four beam deflection units, guides light from the second light source through the objective into the focal plane but not via the first and the second beam deflection units and images a point of the focal plane through the objective onto the detector and the optical system has a light guiding fiber between the first light source and the third beam deflection unit and has no light guiding fibers between the second light source and the third beam deflection unit,
recording a test image through the objective by means of the detector under illumination by the first light source by virtue of the focal plane being scanned by means of the third and fourth beam deflection unit, and the first and/or the second beam deflection unit is set using the recorded test image, in particular in a plurality of iterations of recording a test image and setting the relevant beam deflection unit.

12. The method as claimed in claim 11, wherein the first beam deflection unit, which is arranged optically upstream or downstream of the second beam deflection unit, is set on the basis of a characteristic for illuminating the test image, in particular a homogeneity and/or intensity of the illumination of the test image as the characteristic.

13. The method as claimed in claim 11, wherein the second beam deflection unit is set on the basis of an offset between a reference image recorded under illumination by the second light source and a test image recorded under illumination by the first light source or on the basis of an offset between a first test image recorded under illumination by the first light source and a second test image recorded under illumination by the first light source or by the second light source, wherein the focal plane is displaced by means of an adjustable focusing unit, in particular the objective and/or a collimation optical unit, between the recording of the first and the second test image.
